(19) United States
(12) Patent Application Publication
(10) Pub. No.: US 2023/0152211 A1
(43) Pub. Date: May 18, 2023

(54) System for Optically Analyzing a Test Sample and Method Therefor

(71) Applicant: California Institute of Technology, Pasadena, CA (US)

(72) Inventors: Jack Jewell, Boulder, CO (US); Axel Scherer, Ph.D., Barnard, VT (US); Amirhossein Nateghi, Pasadena, CA (US); Taeyoon Jeon, Pasadena, CA (US)

(21) Appl. No.: 17/984,177

(22) Filed: Nov. 9, 2022

Related U.S. Application Data
(60) Provisional application No. 63/278,162, filed on Nov. 11, 2021.

(51) Int. Cl. G01N 21/03; G01N 1/44; G01N 21/25; G01N 21/35

(52) U.S. Cl. CPC G01N 21/0303; G01N 1/44; G01N 21/35; G01N 21/255

(57) ABSTRACT

The present disclosure is directed toward measurement systems capable of optical analysis of a test sample. Embodiments in accordance with the present disclosure include a sample holder having a plurality of projections that extend from a planar surface, where the projections and planar surface collectively define an open sample-collection surface that enables an interrogation signal direct access to the test sample. The projections can be dimensioned and arranged to collectively define a geometric anti-reflection surface that is substantially non-reflective for the interrogation signal even at large angles of incidence. In some embodiments, the sample holder is configured as a reflective element that enables multiple passes of the interrogation signal through the test sample. In some embodiments, the sample holder is configured as a transmissive element. In some embodiments, the projections themselves are reflective.

### CROSS REFERENCE TO RELATED APPLICATIONS

This case claims priority of U.S. Provisional Pat. Application Serial No. 63/278,162, filed Nov. 11, 2021 (Attorney Docket: CIT-8737-P), which is incorporated herein by reference. If there are any contradictions or inconsistencies in language between this application and one or more of the cases that have been incorporated by reference that might affect the interpretation of the claims in this case, the claims in this case should be interpreted to be consistent with the language in this case.

### FIELD OF THE INVENTION

The present invention relates generally to chemical analysis and, more particularly, to spectroscopy methods, systems, and sample holders suitable for use in optical analysis systems.

### BACKGROUND OF THE INVENTION

Optical analysis methods, such as spectroscopy, and the like, are important analytical tools for identifying analytes contained within a test sample. In spectroscopy, a characteristic pattern of light-absorption peaks is detected, where this pattern is unique to the bonding structure of any chemical. The pattern of absorption peaks for a chemical, therefore, can function as a spectral “fingerprint” for that chemical.

The mid-infrared (MIR) spectral range (defined herein as the wavelengths within the range of approximately 2 microns to approximately 15 microns) represents a particularly information-rich spectral region because of the wealth of absorption peaks that exist within it for most chemicals. The MIR spectral range, therefore, is an attractive operating range for infrared spectroscopy.

Typically, during any optical analysis approach, the test sample is held in a sample holder. Ideally, such a sample holder is “optically efficient” in that it does not significantly affect the optical characteristics imparted by the sample, such as by absorbing wavelengths within the spectral range of the light signal used to interrogate the sample (i.e., the interrogation signal). Unfortunately, sample holders available in the prior art are quite expensive and not particularly optically efficient - particularly those suitable for use in the MIR spectral range. As a result, a lack of suitable sample holders has limited the use of spectroscopy and other optical analysis methods in many applications.

An optical analysis system having a low-cost, optically efficient sample holder would be a significant advance in the state of the art.

### SUMMARY OF THE INVENTION

An advance in the art is made according to aspects of the present disclosure, which describes systems and apparatus for performing optical analysis of a test sample collected on an open sample-collection surface of a sample holder. The sample-collection surface is an exposed structure that is configured to increase the surface area of a planar surface while simultaneously enabling direct optical access to the test sample, thereby facilitating high-performance measurement of its characteristics. Embodiments of the present invention are particularly well suited for use in optical analysis systems, such as spectroscopy systems, calorimetry systems, differential scanning calorimetry Fourier-transform infrared spectroscopy systems, and the like.

An illustrative embodiment in accordance with the present disclosure is an optical analysis system operative for performing mid-infrared spectroscopy on a test sample. The system includes a source of an interrogation signal, which is directed toward a sample holder having an outer front surface that is configured as a sample-collection surface. The sample-collection surface includes a planar surface and a plurality of features that project from the planar surface, thereby increasing its surface area while enabling the interrogation signal to reach the test sample in an unimpeded manner. Each of the plurality of features has a base, sidewall, and tip, where the planar surface, the plurality of sidewalls, and the plurality of tips collectively define the sample-collection surface.

The illustrative sample-holder is reflective such that energy of the interrogation signal passes through the sample twice. In some such embodiments, the sample-collection surface is reflective, while in other such embodiments, the back surface of the sample holder is reflective. In some embodiments, the sample-collection surface is disposed on a reflective coating.

In some embodiments, the features are shaped and/or arranged on the planar surface to collectively define a geometric anti-reflection layer that mitigates reflection of the interrogation signal at the sample-collection surface.

In some embodiments, the sample holder is transmissive such that the interrogation signal passes through the sample once and transits the sample holder, exiting as an output signal that includes information about the test sample. In such embodiments, the back surface of the sample holder is configured to mitigate reflection of the output signal.

In some embodiments, the features are macro-features that hold the test sample and/or improve its interaction with the interrogation signal.

An embodiment in accordance with the present disclosure is an apparatus that includes: a sample holder (106) comprising: a body (302) having a first surface (310) and a plurality of features (308) that project from the first surface, each feature having a sidewall (318) and tip (320); wherein the first surface, the plurality of sidewalls, and the plurality of tips collectively define a sample-collection (SC) surface (116) for locating a test sample (114).

Another embodiment in accordance with the present disclosure is a method comprising: providing a sample holder (106) comprising a body (302) having a first surface (310) and a plurality of features (308) that project from the first surface, each feature having a sidewall (318) and tip (320), wherein the first surface, the plurality of sidewalls, and the plurality of tips collectively define a sample-collection (SC) surface (116) for locating a test sample (114); and collecting the test sample on the sample collection surface.

### BRIEF DESCRIPTION OF THE DRAWINGS

FIG. 1 depicts a block diagram of an illustrative embodiment of a chemical analysis system in accordance with the present disclosure.

FIG. 2 depicts operations of a method for performing analysis of a test sample in accordance with the illustrative embodiment.

FIGS. 3A-B depict schematic drawings of perspective and sectional views of an exemplary reflective sample holder in accordance with the present disclosure.

FIG. 4A depicts a sectional view of a second example of a reflective sample holder in accordance with the present disclosure.

FIG. 4B depicts a sectional view of a third example of a reflective sample holder in accordance with the present disclosure.

FIG. 4C depicts a sectional view of a fourth example of a reflective sample holder in accordance with the present disclosure.

FIGS. 5A-B depict schematic drawings of side and top views of a portion of yet another example of a sample holder in accordance with the present disclosure.

FIG. 6 depicts a block diagram of another exemplary embodiment of an optical analysis system in accordance with the present disclosure.

FIG. 7 depicts a block diagram of yet another embodiment of a chemical analysis system in accordance with the present disclosure.

FIGS. 8A-B depict schematic drawings of perspective and sectional views of an exemplary transmissive sample holder in accordance with the present disclosure.

FIG. 9 depicts measured transmission for a transmissive sample holder in accordance with the present disclosure at different angles of incidence.

FIG. 10 depicts measured transmission through a test sample disposed on the sample-collection surface of a vertically oriented transmissive sample holder in accordance with the present disclosure.

### DETAILED DESCRIPTION

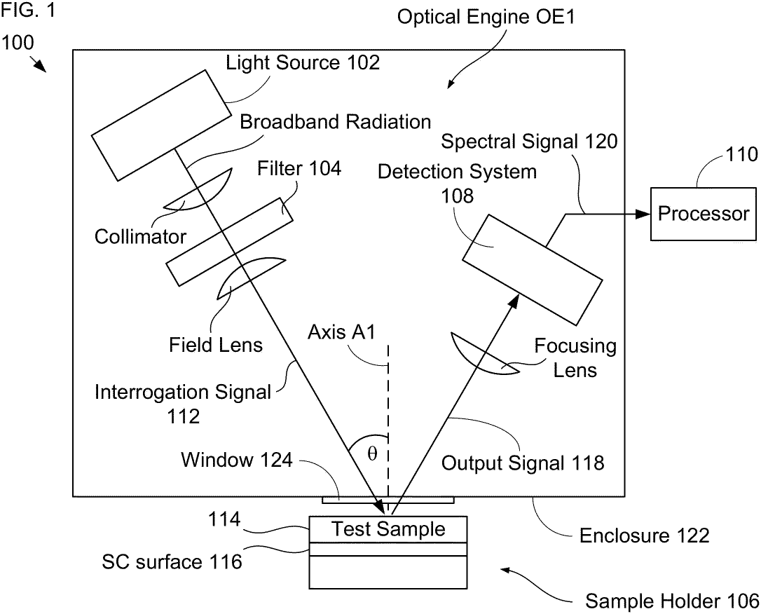

FIG. 1 depicts a block diagram of an illustrative embodiment of a chemical analysis system in accordance with the present disclosure. System 100 is a spectrometer that is operative for analyzing a test sample by determining the absorption characteristics of the test sample over the wavelength range from approximately 2.0 microns to approximately 15 microns (i.e., the mid-infrared spectral range). System 100 includes light source 102, filter 104, sample holder 106, detection system 108, processor 110 and associated optics, such as collimating and focusing lenses, etc.

In the depicted example, light source 102, filter 104, and detection system 108 (and their associated optics) collectively define optical engine OE1.

Optical engine OE1 is optionally contained within enclosure 122, which is a conventional housing that is configured to protect the optical engine, provide a stable environment, protect it from dust and humidity, and the like.

Enclosure 122 includes window 124, which enables optical engine OE1 to provide interrogation signal 122 to a test sample located outside the enclosure and receive output signal 118 from the test sample. In the depicted example, window 124 comprises germanium; however, it will be clear to one skilled in the art, after reading this Specification, how to specify, make, and use a window 124 that includes a different suitable material. Examples of alternative window materials suitable for use in accordance with the present disclosure include, without limitation, silicon (Si), silicon compounds, zinc selenide (ZnSe), and the like.

In some embodiments, enclosure 122 and optical engine OE1 collectively define a portable spectrometer system. Typically, such a portable system also includes a power source, such as a battery, etc.

Although the illustrative embodiment is a spectrometer, the teachings here can be applied to a wide range of optical-analysis instruments, such as other spectrometers, calorimetry systems, and the like.

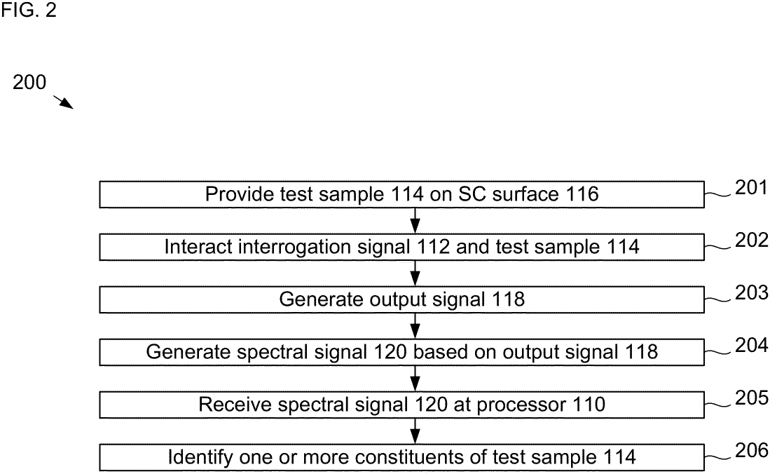

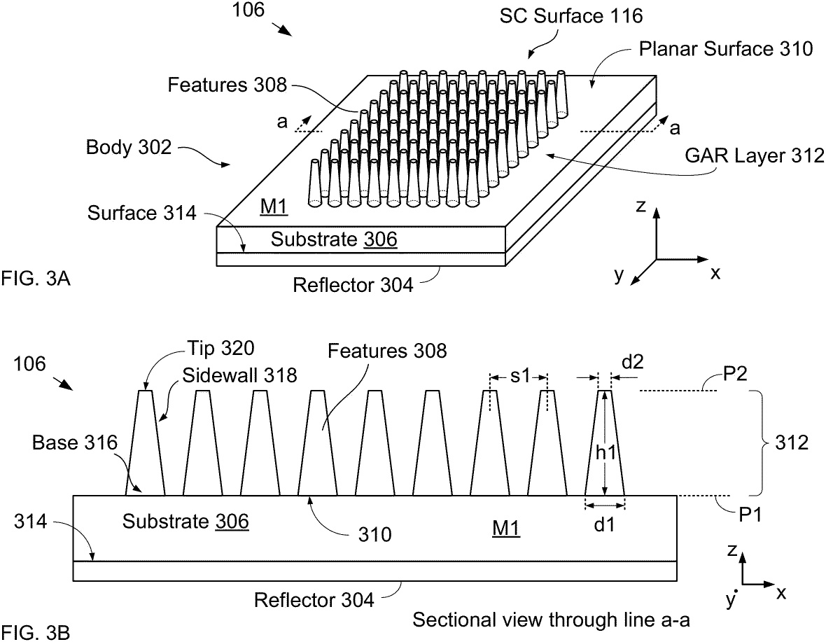

FIG. 2 depicts operations of a method for performing analysis of a test sample in accordance with the illustrative embodiment. Method 200 is described with continuing reference to FIG. 1 as well as reference to FIGS. 3A-B.

Method 200 begins with operation 201, wherein test sample 114 is provided such that it is disposed on sample-collection (SC) surface 116 of sample holder 106.

Sample holder 106 is a sample-collection device that is configured to locate test sample 114 on SC surface 116. In the depicted example, test sample 114 is blood; however, the teachings of the present disclosure can be directed to a wide range of test samples in fluid or fluid-like form (e.g., liquids, gasses, gels, creams, suspensions, mixtures, solutions, biological fluids and sera, etc.). Embodiments in accordance with the present disclosure are particularly well suited for use in the analysis of biological fluids and sera, chemical solutions and compounds, organic solutions, petroleum products, cosmetics, gasses, and the like.

FIGS. 3A-B depict schematic drawings of perspective and sectional views of an exemplary reflective sample holder in accordance with the present disclosure. Sample holder 106 includes body 302 and reflector 304.

Body 302 is a monolithic, homogeneous structure comprising material M1 and includes substrate 306 and features 308, which project from planar surface 310 of the substrate. In the depicted example, body 302 is formed by etching into a surface of substrate 306 to define features 308 and planar surface 310, as described in U.S. Pat. Applications 16/212,499, filed Dec. 6, 2018 (Attorney Docket: 3105-004US1) and 16/212,347, filed Dec. 6, 2018 (Attorney Docket: 3105-005US1), each of which is incorporated herein by reference.

Although sample holder 106 includes a body that is formed by etching into a monolithic substrate, sample holders in accordance with the present disclosure can be formed, at least in part, using any of a wide range of known fabrication techniques such as conventional, precision molding techniques suitable for forming optical elements, MEMS fabrication methods (e.g., deep reactive-ion etching (DRIE), etc.), hybrid fabrication and assembly, and the like. In some embodiments, features are formed on a planar surface of a sample-holder body by depositing material on the surface via, for example, selective-area growth, self-assembly, the Langmuir-Blodgett method, and the like.

Material M1 can be any material suitable that is substantially non-reactive with test sample 114 and does not significantly absorb light at wavelengths within interrogation signal 112. In the depicted example, material M1 is silicon; however, other materials suitable for use in accordance with the present disclosure include, without limitation, germanium, Ultem®, polycarbonate, thermoplastics, optical plastics, glasses, silicones, acrylics, and the like.

Sample holder 106 is configured to reflect the energy of interrogation signal 112 such that it passes through test sample 114 twice. In some embodiments, little or no energy of an interrogation signal passes through sample holder 106 and a wider range of materials can be used in body 302, since the primary considerations are mechanical strength and non-reactivity with test sample 114. In such embodiments, therefore, suitable materials include, without limitation, silicon, polysilicon, silicon compounds (e.g., silicon carbide, silicon germanium, etc.), compound semiconductors, silicon nitrides, oxynitrides, fluorides, ceramics, polymers, composite materials, and the like.

Furthermore, although in the depicted example body 302 is a monolithic, homogeneous structure, in some embodiments, body 302 includes layers and/or regions of different materials.

Each of features 308 includes a base 316, sidewall 318, and tip 320. Each of bases 316 has diameter, d1, and is located at planar surface 310, which defines plane P1, while each of tips 320 has diameter, d2, and is located in plane P2 at a height of h1 above planar surface 310. Features 308 are distributed on planar surface 310 such planar surface 310, sidewalls 318, and tips 320 collectively define SC surface 116.

Furthermore, features 308 are arranged in a two-dimensional arrangement in which they have inter-feature spacing, s1. For the purposes of this Specification, including the appended claims, the term “inter-feature spacing” is defined as the minimum center-to-center spacing between adjacent features of a sample-collection surface.

It is an aspect of the present disclosure that the shape of features 308 and their inter-feature spacing give rise to an ability to hold a liquid test sample, in an open structure, at sample-holder orientations from horizontal through vertical, and even when the sample holder is upside down.

In some embodiments, features 308 are arranged in a periodic fashion in at least one dimension. In some embodiments, features 308 are arranged periodically in two dimensions. In some embodiments, the features are arranged in a non-periodic arrangement. Feature arrangements suitable for use in accordance with the present disclosure include, without limitation, periodic in one or two dimensions, rectilinearly periodic, periodic in two dimensions with different inter-feature spacings, multiple regions having different periodicities, hexagonally close-packed, deterministically aperiodic, randomly periodic, or any other suitable arrangement.

In the depicted example, features 308 are configured to realize a layer having a refractive index that slowly increases in substantially adiabatic fashion from a relatively lower effective refractive index, nₑ, at plane P2 to the refractive index of the material of planar surface 310. As a result, features 308 collectively define geometric anti-reflection (GAR) layer 312, which functions as a graded-index layer that mitigates reflection of light at the wavelengths within interrogation signal 112.

To facilitate anti-reflection characteristics of GAR layer 312, inter-feature spacing s1 (also referred to as “spacing s1”) is preferably smaller than the shortest wavelength in interrogation signal 112. It should be noted, however, that s1 can have any practical dimension without departing from the scope of the present disclosure. In some embodiments, the features are not on a regular spacing. In some embodiments, not all of tips 316 are coplanar in plane P2. Furthermore, in some embodiments, features 308 have different inter-feature spacings in different regions of sample-collection to enable sample holder 106 to concentrate particles, cells, etc., having different dimensions in different regions.

In the depicted example, each of features 308 is a frustum of a cone, h1 is approximately 8 microns, d1 is approximately 1.8 microns, and d2 is approximately 460 nm, and s1 is approximately 2 microns. It should be noted that a wide range of dimensions and spacings for features 308 can be used without departing from the scope of the present disclosure. It should be further noted that a frustum of a cone is merely one example of a suitable shape for features 308 within the scope of the present disclosure, as discussed in U.S. Pat. Application 16/212,499.

Reflector 304 is a conventional reflective element disposed on back surface 314 of substrate 306. In some embodiments, reflector 304 is a conventional broadband reflective element that includes one or more layers of reflective material, such as metals, dielectric layers, metals and dielectric layers, and the like. In the depicted example, reflector 304 comprises a broadband reflector comprising a titanium adhesion layer and a thick, reflective layer of gold. In some embodiments, reflector 304 includes a spectral element, such as a band-rejection filter that reflects radiation in the wavelength range of interest while not reflecting wavelengths outside that range. In some embodiments, reflector 304 includes an edge filter.

As will be understood by one skilled in the art, after reading this Specification, a reflective sample holder advantageously mitigates back-reflections toward light source 102 since it receives interrogation signal 112 at a substantial angle (i.e., incidence angle θ). Furthermore, since light passes through the test sample twice, the absorption of characteristic wavelengths by the chemicals in test sample 114 is enhanced. In fact, as compared to a transmissive sample holder oriented such the interrogation signal is normal on SC surface 116, the path of light through the test sample is more than doubled by a reflective sample holder since it is equal to twice the inverse of the cosine of angle θ_{S} inside the test sample, where angle θₛ is related to the incidence angle θ by Snell’s Law (not shown for clarity).

Returning now to method 200, at operation 202, interrogation signal 112 interacts with test sample 114 to produce output signal 118.

In the depicted example, interrogation signal 112 is provided by light source 102 and filter 104.

Light source 102 is a source, such as a thermal source, operative for providing broadband radiation that includes wavelengths that span the spectral range from approximately 2 microns to approximately 15 microns. In other words, light source 102 is a source of mid-infrared (MIR) radiation. Typically, the light from light source 102 is collimated (via a lens and/or reflector) en route to filter 104.

It should be noted that, for convenience, the term “light” is used throughout this Specification to characterize any radiation on which the described systems operate. However, systems in accordance with this Specification can be configured for use at virtually any wavelengths throughout the electromagnetic spectrum. For example, in some embodiments, system are designed for operation at wavelengths within the ultraviolet spectral range, the visible spectral range, near-infrared spectral range, far-infrared spectral range, as well as at longer wavelengths, such as terahertz, millimeter, microwave, radiowave radiation, and the like. As a result, for the purposes of this Specification, including the appended claims, the term “light” is defined as any radiation within the electromagnetic spectrum.

Filter 104 is spectral filter that receives the broadband radiation from light source 102 and spatially disperses the wavelengths within it along at least one dimension. The spatially dispersed wavelengths are provided by filter 104 as interrogation signal 112. In the depicted example, filter 104 is a hyperspectral filter, such as is described in U.S. Pat. Application 16/782,674, which is incorporated herein by reference. In some embodiments, filter 104 is a different spectral filter. Some non-limiting examples of spectral filters suitable for use in embodiments in accordance with the present disclosure are described in U.S. Pat. Applications 15/065,792 and 15/990,114, each of which is incorporated herein by reference.

Filter 104 is imaged onto detection system 108 by a focusing lens such that interrogation signal 112 passes through test sample 114 twice en route to the detection system.

It should be noted that test sample 114 and sample holder 106 can be located elsewhere in the optical path between light source 102 and detection system 108 without departing from the scope of the present disclosure. For example, in some embodiments, test sample 112 and sample holder 106 can be located:
i. between the focusing lens and detection system 108; or
ii. between light source 102 and the collimator; or
iii. between the collimator and filter 104; or
iv. at other locations in system 100.

At operation 203, the absorption characteristics of test sample 114 are imprinted on interrogation signal 114 to produce output signal 118. Specifically, during each pass of interrogation signal 112 through test sample 114, each constituent chemical in the test sample absorbs some of the energy of the interrogation signal at wavelengths characteristic of that chemical. The resulting light signal, modified by the absorption characteristics of test sample 114, defines output signal 118.

At operation 204, detection system 108 receives output signal 118 and generates spectral signal 120.

In the depicted example, detection system 108 includes a conventional detector array that is configured with filter 104 such that each detector element in the detector array detects a different sub-range of wavelengths (i.e., wavelength signal) within output signal 118. Some non-limiting examples of spectral filters and detector arrays suitable for use in accordance with the present disclosure are described in detail in U.S. Pat. No. 10,488,256, which is incorporated herein in its entirety.

At operation 205, processor 110 receives spectral signal 120 from detection system 108. Spectral signal 120 includes spectral content, such as absorption peaks, that is based on the interaction of interrogation signal 112 with the chemical constituents of test sample 114.

At operation 206, one or more potential chemical constituents in test sample 114 are identified based on the spectral signal 120. Typically, these potential chemical constituents are identified by observing absorption peaks in spectral signal 120 and correlating these absorption peaks with standard absorption spectra for a library of known chemicals stored in a look-up table included in processor 110. In some embodiments, processor 110 includes communications capability that enables it to access a remotely located database that includes such absorption spectra.

In some embodiments, to identify one or more potential chemical constituents in test sample 114, processor 110 performs one or more sub-operations that include:
i. modifying the raw data of spectral signal 120 to correct variations in the response of detection system 108; or
ii. subtracting one or more calibration spectral signals (e.g. spectra taken with no test sample 114, taken with a different filter 104, etc.) from spectral signal 120; or
iii. modifying spectral signal 120 to, for example, decrease noise, increase contrast, decrease contrast, and the like; or
iv. applying thresholding to spectral signal 120 to enhance detectability; or
v. applying artificial intelligence techniques to improve analysis of spectral signal 120; or
vi. any combination of i, ii, iii, iv, and v.

It should be noted that sample holder 106 is merely one example of a reflective sample holder suitable for use in optical analysis systems in accordance with the present disclosure.

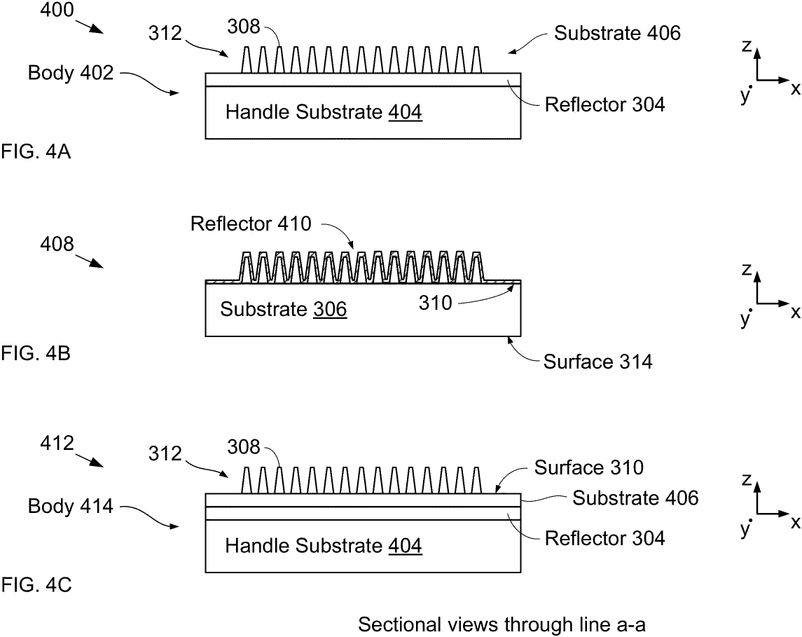

FIG. 4A depicts a sectional view of a second example of a reflective sample holder in accordance with the present disclosure. Sample holder 400 is analogous to sample holder 106; however, in sample holder 400, reflector 304 is immediately beneath features 308 and functions as surface 310. The sectional view shown in FIG. 4A is analogous to the sectional view of sample holder 106 taken along line a-a, as shown in FIG. 3B.

In the depicted example, body 402 includes features 308, reflector 304, and handle substrate 404.

Reflector 304 is disposed on the top surface of handle substrate 404. As will be apparent to one skilled in the art, after reading this Specification, handle substrate 404 can be any substrate having suitable mechanical strength and optical flatness. Preferably, reflector 304, substrate 406 and features 308 are all non-reactive with test sample 114.

In the depicted example, features 308 are formed by etching them from substrate 406, which is provided such that it is disposed directly on reflector 304. Suitable methods for providing substrate 406 such that it is disposed on reflector 304 include, without limitation, wafer bonding, hybrid assembly, mechanical application, and the like. In some embodiments, substrate 406 is a layer of material that is formed on reflector 304 by a conventional process such as evaporation, spin coating, sputter deposition, etc.

As will be appreciated by one skilled in the art, after reading this Specification, the energy of interrogation signal 112 must pass through the material of substrate 406 twice in sample holder 400 but does not pass through handle substrate 404. Therefore, the material of the handle substrate does not need to be transmissive, nor does its back surface need to be polished to mitigate scatter. Additionally, since interrogation signal 112 is highly reflected from reflector 304, features 308 may or may not define a GAR layer, or may have intermediate reflectivity, however a GAR layer is likely to substantially maximize the interaction of interrogation signal 112 with test sample 114.

In addition to the methods described briefly above, myriad alternative fabrication methods can be used to produce sample holder 400, such as:
i. forming reflector 304 on handle substrate 404, producing features 308 in substrate 406, and subsequently joining substrate 406 and the reflector; or
ii. forming reflector 304 on handle substrate 404, forming a material layer onto reflector 304, and forming features 308 in or on the material layer; or
iii. forming features 308 in reflector 304; or
iv. any other suitable fabrication process.

FIG. 4B depicts a sectional view of a third example of a reflective sample holder in accordance with the present disclosure. Sample holder 408 is analogous to sample holders 106 and 400; however, sample holder 408 includes reflector 410, which is disposed on features 308. The sectional view shown in FIG. 4B is analogous to the sectional view of sample holder 106 taken along line a-a, as shown in FIG. 3B.

Reflector 410 is analogous to reflector 304 and includes one or more metal layers and/or one or more dielectric layers.

Since transmission through features 308 is not necessary in the depicted example (as well as some other embodiments in accordance with the present disclosure), the spacing and dimensions of features 308 can have any suitable value that affords the ability for the features to hold test sample 114. As a result, in some embodiments, features 308 are configured to alter the reflected light for one or more desired characteristics, such as reflectivity control, beam control, beam steering, beam focusing, spectral dispersion, polarization control, enhancing beam coupling into a waveguide or other structure, and the like.

FIG. 4C depicts a sectional view of a fourth example of a reflective sample holder in accordance with the present disclosure. Sample holder 412 is analogous to sample holder 400; however, in sample holder 412, body 414 includes features 308, a portion of substrate 406, and handle substrate 404, where features 308 are formed such that they do not extend through the entire thickness of substrate 406. As a result, reflector 304 is in close proximity to features 308 beneath the unetched portion of substrate 406. Preferably, the unetched portion of substrate 406 is very thin (e.g., much thinner than substrate 306). The sectional view shown in FIG. 4C is analogous to the sectional view of sample holder 106 taken along line a-a, as shown in FIG. 3B.

For some embodiments in which a sample holder is configured for reflective-mode operation, the dimensions and arrangement of features 308 are based on one or more characteristics of test sample 114, such as its viscosity, surface tension with respect to material M1, the desired thickness of the test sample when disposed on the sample holder, and the like. In such embodiments, features 308 are configured primarily based on their ability to hold the test sample in place and, in some cases, to optimize the reflected-light characteristics.

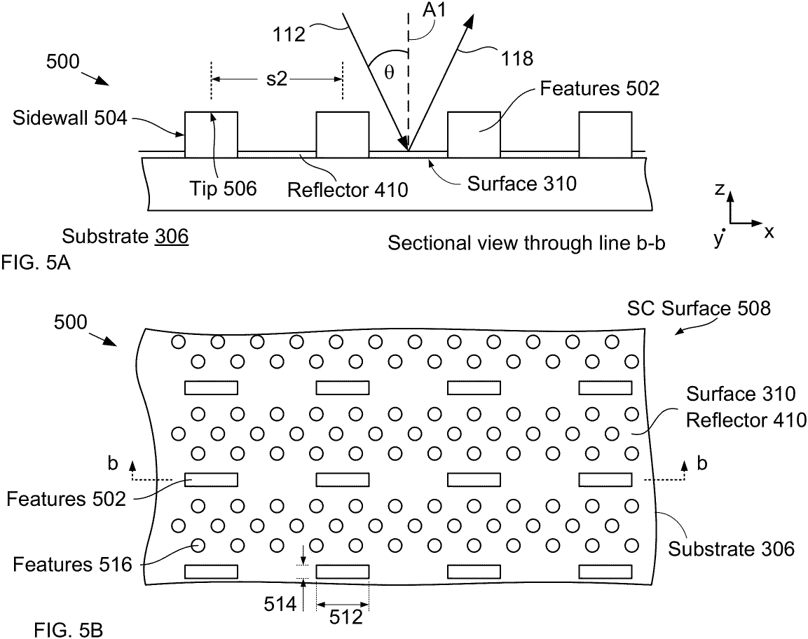

FIGS. 5A-B depict schematic drawings of side and top views of a portion of yet another example of a sample holder in accordance with the present disclosure. Sample holder 500 is analogous to sample holder 106; however, in sample holder 500, features 502 are optimized to effectively hold a test sample 114, and do not need anti-reflection properties. Features 502 may be asymmetric (e.g. approximately rectangular with a long dimension 512 and short dimension 514, etc.) Furthermore, although the depicted example includes rectangular features, features 502 can have virtually any shape (e.g., square, circular, triangular, rhomboidal, elliptical, irregular, etc.) without departing from the scope of the present disclosure.

Like features 308, each of features 502 projects from planar surface 310 and comprises sidewall 504 and tip 506 such that the planar surface, sidewalls, and tips collectively define SC surface 508. However, features 502 are much larger than typical features 308, having lateral dimension on the order of microns or millimeters. It should be noted, however, that features 502 can have any practical lateral dimensions without departing from the scope of the present disclosure.

Features 502 are dimensioned and arranged to both effectively hold test sample 114 and substantially optimize the reflective characteristics of SC surface 508. As such, features 502 have an inter-feature spacing, s2, which is selected such that tips 506 occupy only a small fraction of the total area of SC surface 508. As a result, most of the light of interrogation signal 112 reflects from reflector 410 on planar surface 310 without striking sidewalls 504 while completing a double pass through test sample 114. In some embodiments, reflector 410 is also disposed on sidewalls 504 and/or tips 506.

It should be noted that FIG. 5B shows optional features 516, which are included in some embodiments in at least some of the regions between features 502 to provide additional optical and other functionality, such as anti-reflection capability, spectral filtering, test sample retention, and the like.

Preferably, planar surface 310 is “optically flat” so that the beam quality of interrogation signal 112 is preserved as it reflects from the planar surface.

Furthermore, it should be noted that features 502 can be included in the SC surface of any sample holder in accordance with the present disclosure without departing from its scope. In some embodiments, features 502 are located only at the perimeter of a SC surface, thereby enclosing the SC surface within a border.

It should be further noted that sample holder 500 need not include any elements that give rise to a significantly wavelength-sensitive response. Most simple optical-surface components, such as thin-film coatings or features 308 can be configured such that they are effective over a wavelength range spanning a factor of about 2-3 (e.g. 7-to-15 microns, etc.). For example, in embodiments in which a layer of gold is used for reflector 304, the reflector will be highly reflective (90% or more) over a wavelength range that spans from 2 to 20 microns or more.

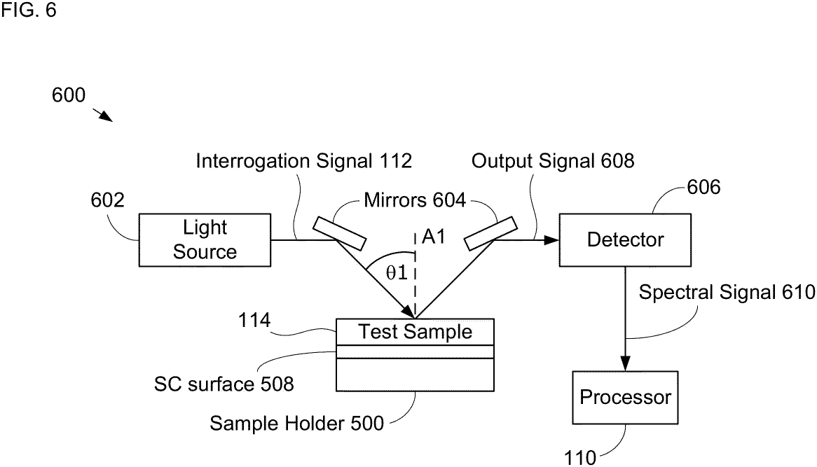

FIG. 6 depicts a block diagram of another exemplary embodiment of an optical analysis system in accordance with the present disclosure. System 600 is analogous to system 100; however, system 600 is a Fourier-Transform Spectrometer (FTS) that includes light source 602, mirrors 604, sample holder 500, detector 606, and processor 110, as well as associated optics, such as a collimator, focusing lens, and the like (not shown for clarity). In some embodiments, system 600 is an optical analysis system other than an FTS.

Light source 602 is analogous to light source 102 and filter 104; however, light source 602 is configured such that it can be translated to change the length of the optical path between itself and detector 606.

Mirrors 604 are conventional reflectors suitable for redirecting interrogation signal 112 toward test sample 114 and output signal 606 toward detector 606 after the output signal is reflected by the test sample. In some embodiments, at least one of mirrors 604 includes spectral filtering capability.

Detector 606 is a conventional detector configured to receive energy of interrogation signal 112 from test sample as output signal 608 and provide spectral signal 610 to processor 110.

It should be noted that, although the depicted example includes sample holder 500, any reflective sample holder in accordance with the present disclosure can be used in system 600.

Although the optical analysis systems discussed thus far are configured to operate in reflection mode, the teachings of the present disclosure are also suitable for use in optical analysis systems that operate in transmission mode (i.e., in which an interrogation beam passes completely through a test sample and its sample holder).

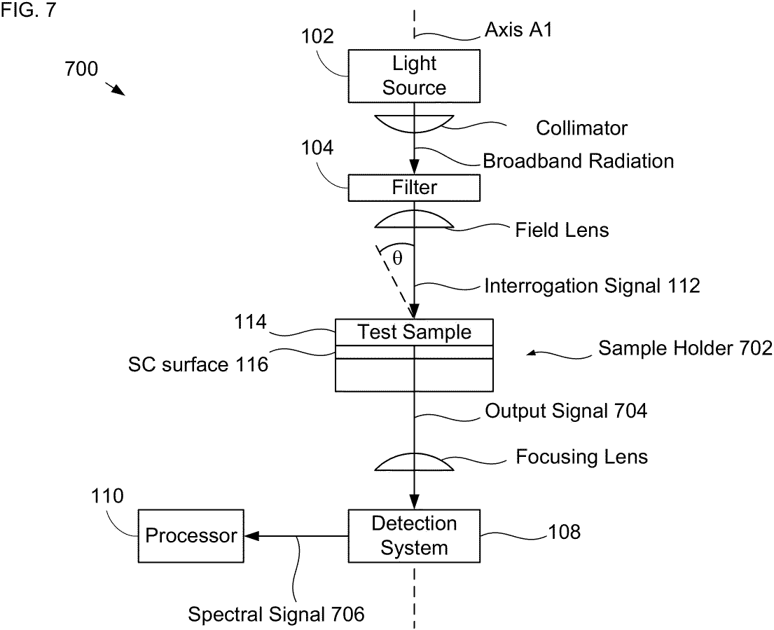

FIG. 7 depicts a block diagram of yet another embodiment of a chemical analysis system in accordance with the present disclosure. System 700 is a spectrometer that is operative for analyzing a test sample by determining the absorption characteristics of the test sample over the wavelength range from approximately 2.0 microns to approximately 15 microns (i.e., the mid-infrared spectral range). System 700 includes light source 102, filter 104, sample holder 702, detection system 108, processor 110 and associated optics, such as collimating and focusing lenses, etc.

Sample holder 702 is analogous to sample holder 106; however, sample holder 702 is configured to enable the energy of interrogation signal 112 to pass through it and emerge as output signal 704. Output signal 704 is analogous to output signal 118.

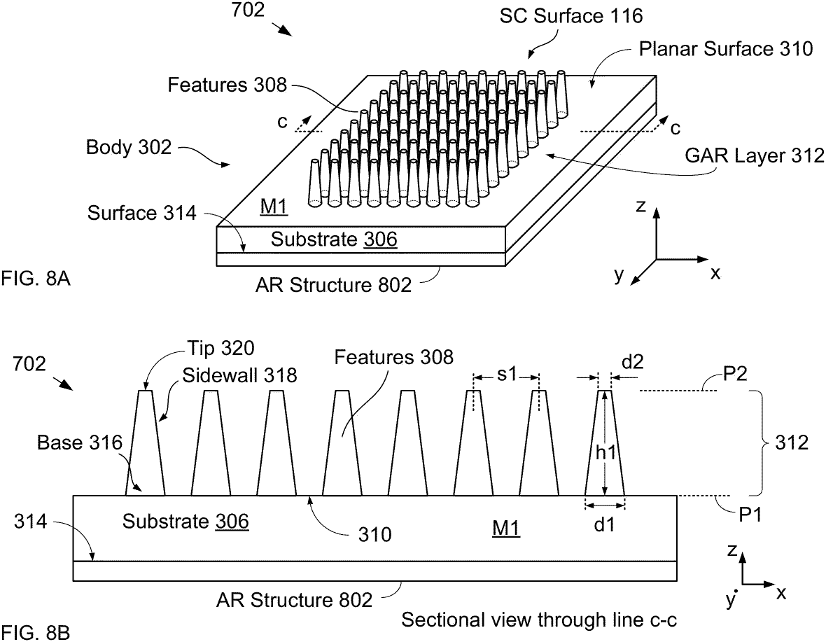

FIGS. 8A-B depict schematic drawings of perspective and sectional views of an exemplary transmissive sample holder in accordance with the present disclosure. Sample holder 702 includes body 302 and AR structure 802. The sectional view shown in FIG. 8B is taken through line c-c as shown in FIG. 8A.

AR structure 802 is formed on or in surface 314 and is configured to mitigate reflection of the wavelengths included in interrogation signal 112 at that surface.

In the depicted example, AR structure 802 is a second GAR layer 312. In some embodiments, AR structure 802 includes a different anti-reflection structure, such as a GAR layer having a different feature configuration, a conventional anti-reflection coating comprising one or more material layers, such as dielectric materials (e.g., germanium, zinc selenide, etc.), and the like. It will be clear to one skilled in the art, after reading this Specification, how to specify, make, and use AR structure 802.

In some embodiments, AR structure 802 has functionality beyond just simple reflection suppression. For example, in some embodiments, AR structure 802 functions as a spectral filter, such as:
i. an edge filter that passes only wavelengths longer than a particular wavelength within interrogation signal 112; or
ii. an edge filter that passes only wavelengths shorter than a particular wavelength within interrogation signal 112; or
iii. a bandpass filter that transmits only a wavelength range and rejects (reflects or absorbs) wavelengths outside the range; or
iv. any combination of i, ii, and iii.

In the depicted example, interrogation signal is incident on the test sample and sample holder at incidence angle, θ1, relative to axis A1, where axis A1 is normal to planar surface 310. In the depicted example, A1 is 0° such that interrogation signal 112 is aligned with axis A1. However, it is an aspect of the present disclosure that transmissive and reflective sample holders having a sample-collection surface as taught herein has less angular sensitivity than sample holders of the prior art. As a result, a sample-holder in accordance with the present disclosure can be aligned at angles of up to at least 40° between its normal axis, A1, and the propagation direction of interrogation signal 112, thereby increasing the optical path length of the interrogation signal through analyte and improving the sensitivity of an optical measurement system.

It should be noted that, in such embodiments, AR structure 802 preferably retains its low-reflection characteristics.

In some embodiments, AR structure 802 has additional optical functionality. For example, in some embodiments, AR structure 802 includes a metasurface configured to function as field lens, focusing lens, beam deflector and the like.

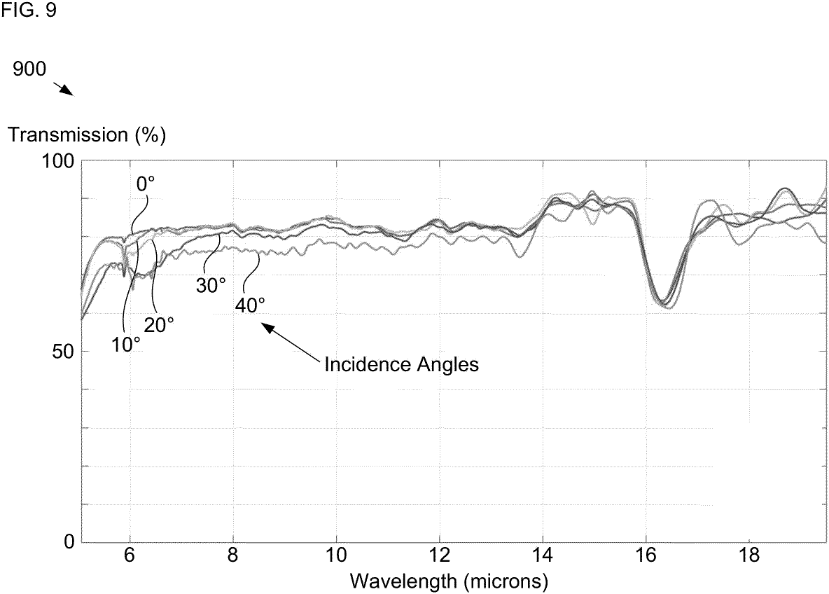

FIG. 9 depicts measured transmission for a transmissive sample holder in accordance with the present disclosure at different angles of incidence. Plot 900 includes traces of the transmissivity of sample holder 106 for an interrogation signal received at incidence angles, θ, of 0, 10, 20, 30, and 40 degrees (relative to normal axis A1), respectively.

As evinced by plot 900, for angles of incidence up to 20 degrees, sample holder 106 has approximately 80% transmission for the spectral range that spans from approximately 5 microns to approximately 15 microns, which encompasses most of the entire MIR spectrum . It should be noted that, as a point of comparison, a plain, unstructured silicon substrate exhibits approximately 30% reflection from each of its surfaces; therefore, would have a transmission of approximately 50%.

Furthermore, plot 900 indicates that transmission is not severely degraded even for angles of incidence between 20 degrees and 40 degrees, with only a slight loss of transmission for wavelengths below about 7 microns.

As the wavelength of light approaches the value of s1, some degradation in transmission becomes evident. For example, for wavelengths less than approximately 5.5 microns (i.e., approximately 2.75 times s1), transmission begins to decline and more dependence on angle of incidence is evident. It should be noted, however, that reflection is also reduced at wavelengths less than 2.75 times s1; therefore, it is preferably that features 308 have an inter-feature spacing, s1, that is less than about 1/2.75 of the wavelength of interest. In many cases, but not all, the value of s1 is based on the shortest wavelength, λₘ, included in interrogation signal 112.

It is an aspect of the present disclosure, therefore, that the inter-feature spacing, s1, is preferably less than approximately one-half the shortest wavelength in interrogation signal 112.

Still further, at longer wavelengths, the transmission increases and has less angular dependence than at the shorter wavelengths. For a 2-micron wavelength, GAR layer 312 can be effective with s1 being less than 2 microns; however, it would be more effective with s1 being less than 2/2.75 (0.72) microns. In other cases, such as for a 100-micron wavelength (i.e., 3 Terahertz frequency), GAR layer 312 can be effective with s1 being less than 200 microns; however, it would be more effective with an s1 of less than 36 microns. In similar fashion, for radiation having a wavelength of 10,000 microns (i.e., 10 millimeters), GAR layer 312 can be effective with s1 being less than 20 millimeters; however, it would be more effective with s1 being less than 3.6 millimeters. It should be noted the wavelengths discussed here are merely exemplary and that scaling of the inter-feature spacing, s1, scales with substantially any wavelength of radiation.

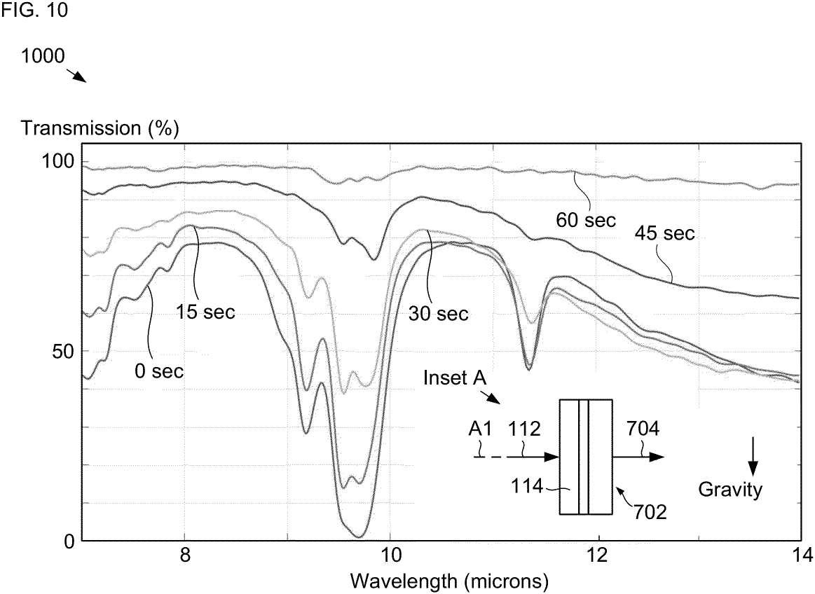

FIG. 10 depicts measured transmission through a test sample disposed on the sample-collection surface of a vertically oriented transmissive sample holder in accordance with the present disclosure. Plot 1000 includes traces of the transmission of interrogation signal 112 through a test sample composed of a 1:1 mixture of ethanol and methanol at different times after the test sample is dispensed on SC surface 116.

It is an aspect of the present disclosure that a sample holder configured as taught herein can be oriented at a wide range of angles relative to the propagation direction of interrogation signal 112, as well as to the direction of gravity. The fact that sample holders disclosed herein enable direct access to a test sample, while still retaining even a liquid sample on SC surface 116 (as noted above) at extreme orientations with respect to gravity, affords embodiments in accordance with the present disclosure significant advantages over optical analysis systems of the prior art.

Inset A shows the orientation of test sample 114 and sample holder 702 during the measurements made to generate plot 1000. As indicated, the normal axis A1 of sample holder 106 is held such that it is aligned with the direction of propagation of interrogation signal 112 and output signal 704 and perpendicular to the direction of gravity. As a result, test sample 114 is open to direct access by interrogation signal 112; however, there is nothing to keep the test sample in place on SC surface 116 other than its adhesion to features 308 arising from surface tension.

It is an aspect of the present disclosure that, by configuring sample holder 106 such that test sample 114 is “open to the environment” while loaded in the sample holder, it is easy to rapidly prepare the test sample. Furthermore, such a configuration facilitates high-fidelity measurement of the light transmission/absorption by the test sample (and/or other properties of the test sample).

Plot 1000 shows that the absorption characteristics of test sample 114 change over time as the volatile ethanol and methanol evaporate at different rates due to the fact that test sample 114 is open to the environment.

It is to be understood that the disclosure teaches just some embodiments in accordance with the present disclosure and that many variations of the invention can easily be devised by those skilled in the art after reading this disclosure and that the scope of the present invention is to be determined by the following claims.

What is claimed is:

1. An apparatus that includes:
a sample holder (106) comprising:
a body (302) having a first surface (310) and a plurality of features (308) that project from the first surface, each feature having a sidewall (318) and tip (320);
wherein the first surface, the plurality of sidewalls, and the plurality of tips collectively define a sample-collection (SC) surface (116) for locating a test sample (114).

2. The apparatus of claim 1 wherein the first plurality of projections defines a first geometric anti-reflection (GAR) layer (312) that mitigates reflection of a first light signal (118) at the SC surface.

3. The apparatus of claim 2 wherein the body has a second surface (314) that is distal to the first surface, and wherein the second surface comprises an anti-reflection (AR) structure (304) that is configured to mitigate reflection of the first light signal (118) at the second surface.

4. The apparatus of claim 3 wherein the AR structure comprises a structure selected from the group consisting of a second geometric anti-reflection (GAR) layer, an anti-reflection coating, and a spectral filter.

5. The apparatus of claim 2 wherein the first light signal includes a first wavelength, λm, and wherein the first plurality of projections is characterized by an inter-feature spacing (s1) that is less than or equal to λm/2 in at least one dimension.

6. The apparatus of claim 2 wherein the inter-feature spacing (s1) that is less than or equal to λm/2.75 in at least one dimension.

7. The apparatus of claim 2 wherein the GAR layer mitigates reflection of the first light signal when the first light signal has an angle of incidence (θ) on the body that is within the range from -40 degrees to +40 degrees.

8. The apparatus of claim 1 wherein the sample holder includes a reflector (304) that is configured to reflect light into the test sample after the light has already passed through the test sample.

9. The apparatus of claim 8 wherein the body has a second surface (314) that is distal to the first planar surface, and wherein the reflector is disposed on the second surface.

10. The apparatus of claim 8 wherein the reflector (304) is located between the first surface and the second surface.

11. The apparatus of claim 8 wherein the reflector (410) is disposed on the first surface and the plurality of projections.

12. The apparatus of claim 8 wherein the reflector (304) comprises a spectral filter.

13. The apparatus of claim 1 further comprising:
a light source (102) for providing a first light signal (112) characterized by a plurality of wavelengths;
a spectral filter (104) for spatially dispersing the plurality of wavelengths along at least one dimension; and
a detection system (108) that is arranged to detect at least some of the plurality of wavelengths after it has passed through the test sample.

14. The apparatus of claim 1 wherein the SC surface is configured to retain the test sample at all orientations of the sample holder with respect to gravity.

15. A method comprising:
providing a sample holder (106) comprising a body (302) having a first surface (310) and a plurality of features (308) that project from the first surface, each feature having a sidewall (318) and tip (320), wherein the first surface, the plurality of sidewalls, and the plurality of tips collectively define a sample-collection (SC) surface (116) for locating a test sample (114); and
collecting the test sample on the sample collection surface.

16. The method of claim 15 wherein the sample holder is provided such that the plurality of features defines a first geometric anti-reflection (GAR) layer (312) that mitigates reflection of a first light signal (118) at the SC surface.

17. The method of claim 16 wherein the sample holder is provided such that the body has a second surface that is distal to the first surface, and wherein the second surface comprises an anti-reflection (AR) structure (304) that is configured to mitigate reflection of the first light signal (118) at the second surface.

18. The method of claim 17 wherein the AR structure comprises a structure selected from the group consisting of a second geometric anti-reflection (GAR) layer, an anti-reflection coating, and a spectral filter.

19. The method of claim 15 wherein sample holder is provided such that it includes a reflector (702) that is configured to reflect light into the test sample after the light has already passed through the test sample.

20. The method of claim 19 wherein sample holder is provided such that the body has a second surface (314) that is distal to the first planar surface, and wherein the reflector is disposed on the second surface.

21. The method of claim 19 wherein the reflector is located between the first surface and the second surface.

22. The method of claim 19 wherein the reflector (410) is disposed on the first surface and the plurality of projections.

23. The method of claim 15 further comprising:
interacting an interrogation signal (112) and the test sample to produce an output signal (118), wherein the output signal is based on the interrogation signal and at least one absorption characteristic of the test sample; and
identifying at least one chemical constituent in the test sample based on the output signal.
